(19) United States
(12) Patent Application Publication
(10) Pub. No.: US 2010/0055376 A1
(43) Pub. Date: Mar. 4, 2010

(54) ULTRAVIOLET-CURABLE COMPOSITION FOR OPTICAL DISC AND OPTICAL DISC

(75) Inventors: Hirokazu Saito, Ageo-shi (JP); Koichi Fujii, Niiza-shi (JP)

Correspondence Address: DARBY & DARBY P.C., P.O. BOX 770, Church Street Station, New York, NY, 10008-0770, US

(73) Assignee: DIC Corporation, Tokyo (JP)

(21) Appl. No.: 12/546,429

(22) Filed: Aug. 24, 2009

(30) Foreign Application Priority Data
Aug. 26, 2008 (JP) 2008-216545

(51) Int. Cl. B32B 3/02; C08K 5/3492

(52) U.S. Cl. 428/65.1; 524/720

(57) ABSTRACT

The present invention provides an ultraviolet-curable composition that inhibits deterioration of a reflective layer during environmental changes in humidity and temperature even when using silicon or a silicon compound for the light reflecting layer, and an optical disc enabling preferable reading and writing of recording signals even during environmental changes in humidity and temperature.

In particular, occurrence of deterioration at the interface between a cured coating film of an ultraviolet-curable composition and a silicon reflective layer can be decreased and the formation of minute white'spots, for which there is the risk of impairing reading and writing of signals, can be effectively inhibited even in a high-temperature and high-humidity environment by using an ultraviolet-curable composition comprising a (meth)acrylate oligomer, a (meth)acrylate monomer and an antioxidant, wherein the antioxidant is an antioxidant having an isocyanuric acid backbone, and the chlorine content in the composition is less than 120 ppm.

### CROSS REFERENCE TO PRIOR APPLICATIONS

This is a U.S. patent application claiming priority to a Japanese Patent Application No. 2008-216545, filed Aug. 26, 2008 which is incorporated by reference herein.

### BACKGROUND ART

Digital Versatile Discs (DVDs), which constitute the mainstream of high-density recordable optical discs, have a structure in which two substrates having a thickness of 0.6 mm are laminated with an adhesive. A laser having a shorter wavelength of 650 nm is used and a higher numerical aperture is used for the optical system of DVD in order to achieve higher density when compared to Compact Discs (CDs).

Although there are various variations in the process used to produce DVDs, they are basically produced by a method in which at least one substrate has an information recording layer and two substrates are laminated together, and at that time, an ultraviolet-curable composition is used as an adhesive.

In the case of a read-only use DVD, DVDs are classified in the manner of DVD-5, DVD-10, DVD-9 or DVD-18 according to differences in the constitution of the two laminated substrates. Although the details of these constitutions are disclosed by known documents (see, for example, Japanese Unexamined Patent Application, First Publication No. H10-3699 and Japanese Unexamined Patent Application, First Publication No. 2001-266419), an overview thereof is described below.

Concave-convexes known as pits corresponding to recorded information are provided in one side of both of the two laminated substrates, and an information recording layer (also referred to as a reflective layer) is formed by providing a film that reflects laser light for reading information in the form of an aluminum layer so as to cover the concave-convexes of the pits. A DVD in which this is used as a reflective film of laser light and two information recording layers are laminated in opposition is classified as “DVD-10”, that in which one of the two layers uses a transparent substrate that does not have an information recording layer is classified as “DVD-5”, and that in which concave-convexes of pits corresponding to recorded information are provided on one substrate and a translucent reflective layer composed of gold or silicon compound (information recording layer) is formed so as to cover the pits, while an aluminum reflective layer (information recording layer) is formed on the other substrate is classified as “DVD-9”. Moreover, that having a structure in which two substrates each having two layers consisting of a reflective layer and a translucent reflective layer on one side are laminated is classified as “DVD-18”. These DVDs are used according to the particular application.

In optical discs such as DVDs, silver or silver alloys and silicon or silicon compounds are used for the transparent or translucent light reflecting layer, and a curable coating film of an ultraviolet-curable composition is widely used for the light transmitting layer that protects the light reflecting layer or adhesive layer that laminates a substrate having a light reflecting layer. Although silicon or a silicon compound is inexpensive, when silicon or a silicon compound is used for the light reflecting layer of an optical disc, the surface of the light reflecting layer became cloudy in a high-temperature and high-humidity environment, causing impairment during reading and writing of signals depending on the laminated ultraviolet-curable composition.

In order to resolve this problem, an ultraviolet-curable resin composition using oligo[2-hydroxy-2-methyl-1-[4-(1-methylvinyl)phenyl]propanone] for the photopolymerization initiator is disclosed as an ultraviolet-curable resin composition capable of forming an optical disc having high durability even when using silicon or a silicon compound for the light reflecting layer (see Japanese Unexamined Patent Application, First Publication No. 2005-68348). This composition is a composition that is able to inhibit clouding of the silicon reflective film during environmental changes in humidity and temperature by using a specific photopolymerization initiator.

However, although this ultraviolet-curable composition is able to prevent clouding by visual observation during environmental changes in humidity and temperature, minute white spots are sporadically observed in microscopic observations of the silicon reflective layer surface, thereby impairing reading and writing of information in optical discs requiring even higher density recording.

### SUMMARY OF THE INVENTION

An object of the present invention is to provide an ultraviolet-curable composition that inhibits deterioration of a reflective layer during environmental changes in humidity and temperature even when using silicon or a silicon compound for the light reflecting layer, and to provide an optical disc enabling preferable reading and writing of recording signals even during environmental changes in humidity and temperature.

The ultraviolet-curable composition of the present invention is able to decrease occurrence of deterioration at the interface of a cured coating film of the ultraviolet-curable composition and a silicon reflective layer and effectively inhibit the formation of minute white spots for which there is the risk of impairing reading and writing of signals even in a high-temperature and high-humidity environment, by containing an antioxidant having an isocyanuric acid backbone having high affinity for a silicon reflective layer surface in a composition in which the content of chlorine components, which are presumed to be one of the factors responsible for deterioration of the silicon reflective layer surface, has been decreased.

Namely, the present invention provides an ultraviolet-curable composition for an optical disc comprising a (meth)acrylate oligomer, a (meth)acrylate monomer and an antioxidant, wherein the antioxidant is an antioxidant having an isocyanuric acid backbone, and the chlorine content in the composition is less than 120 ppm.

Since the ultraviolet-curable composition for an optical disc of the present invention is able to inhibit minute deterioration occurring in the silicon reflective layer surface that is not inhibited by compositions of the prior art, signal characteristics can be expected to be improved, thereby making this useful for an optical disc enabling preferable reading and writing of signals when applied to an optical disc for high-density recording.

### BRIEF DESCRIPTION OF THE DRAWINGS

FIG. 1 shows the results of observing appearance following durability testing of an optical disc produced in Example 1 of the present invention (magnification: 25×).

FIG. 2 shows the results of observing appearance following durability testing of an optical disc produced in Example 3 of the present invention (magnification: 25×).

FIG. 3 shows the results of observing appearance following durability testing of an optical disc produced in Comparative Example 1 of the present invention (magnification: 25×).

FIG. 4 shows the results of observing appearance following durability testing of an optical disc produced in Comparative Example 3 of the present invention (magnification: 25×).

### DETAILED DESCRIPTION OF THE INVENTION

The ultraviolet-curable composition for an optical disc of the present invention contains a (meth)acrylate oligomer, a (meth)acrylate monomer and an antioxidant, the antioxidant is an antioxidant having an isocyanuric acid backbone, and the chlorine content in the composition is less than 120 ppm.

[(Meth)acrylate Oligomer]

Various types of oligomers used in the light transmitting layer or adhesive layer of an optical disc can be used for the (meth)acrylate oligomer used in the present invention and urethane (meth)acrylate and epoxy (meth)acrylate can be used preferably.

In the present invention, since it is easy to prepare an oligomer having a low chlorine content, urethane (meth)acrylate is preferably used for the (meth)acrylate oligomer.

Urethane (meth)acrylate obtained from, for example, compounds having two or more isocyanurate groups in a molecule thereof, compounds having a hydroxyl group and a (meth)acryloyl group, and compounds having two or more hydroxyl groups in a molecule thereof can be preferably used for the urethane (meth)acrylate. In addition, urethane (meth)acrylate obtained by reacting a compound having a hydroxyl group and a (meth)acryloyl group with a compound having two isocyanurate groups in a molecule thereof can also be used preferably.

Examples of compounds having two or more isocyanurate groups in a molecule thereof include polyisocyanates such as tetramethylene diisocyanate, hexamethylene diisocyanate, trimethylhexamethylene diisocyanate, bis(isocyanatomethyl) cyclohexane, cyclohexane diisocyanate, bis(isocyanatocyclohexyl) methane, isophorone diisocyanate, 2,4-tolylene diisocyanate, 2,6-tolylene diisocyanate, xylene diisocyanate, diphenylmethane diisocyanate or m-phenylene diisocyanate. In particular, diisocyanate compounds having two isocyanate groups in a molecule thereof can be used preferably, and tolylene diisocyanate is particularly preferable since it does not demonstrate exacerbation of hue or decreases in light transmittance.

Examples of compounds having a hydroxyl group and a (meth)acryloyl group include hydroxyethyl (meth)acrylate, hydroxypropyl (meth)acrylate and hydroxybutyl (meth)acrylate, as well as compounds obtained by reacting these (meth)acrylates with compounds having two or more hydroxyl groups. Other examples include compounds obtained by reacting compounds having two or more hydroxyl groups with (meth)acrylic acid, such as addition reaction products of glycidyl ether compounds and (meth)acrylic acid, or mono(meth)acrylates of glycol compounds.

Polyols are preferably used as compounds having two or more hydroxyl groups, and specific examples thereof include high molecular weight polyols in the form of oligomers of alkylene polyols and the like, such as ethylene glycol, 1,2-propanediol, 1,3-propanediol, 2-methyl-1,3-propanediol, 1,3-butanediol, 1,4-butanediol, 1,5-pentanediol, 2-methyl-1,5-pentanediol, neopentyl glycol, 3-methyl-1,5-pentanediol, 2,3,5-trimethyl-1,5-pentanediol, 1,6-hexanediol, 2-ethyl-1,6-hexanediol, 2,2,4-trimethyl-1,6-hexanediol, 1,8-octanediol, trimethylolpropane, pentaerythritol, sorbitol, mannitol, glycerin, 1,2-dimethylolcyclohexane, 1,3-dimethylolcyclohexane or 1,4-dimethylolcyclohexane.

In particular, polyether polyols having ether bonds, polyester polyols having ester bonds obtained by a reaction with a polybasic acid or a ring-opening polymerization of a cyclic ester, or polycarbonate polyols having carbonate bonds obtained by a reaction with a carbonate are preferable. At least a portion of these polyols, preferably 15 mol % or more of the total amount of the polyols, and more preferably 30 mol % or more of the total amount of the polyols, preferably has a molecular weight of 500 to 2500.

In addition to oligomers of the aforementioned polyols, examples of polyether polyols include polytetramethylone glycol in the form of a ring-opened polymer of a cyclic ether such as tetrahydrofuran, and alkylene oxide addition products of the aforementioned polyols, such as ethylene oxide, propylene oxide, 1,2-butylene oxide, 1,3-butylene oxide, 2,3-butylene oxide, tetrahydrofuran, styrene oxide or epichlorhydrin.

Examples of polyester polyols include reaction products of the aforementioned polyols with polybasic acids such as maleic acid, fumaric acid, adipic acid, sebacic acid or phthalic acid, and polycaprolactones in the form of ring-opened polymers of cyclic esters such as caprolactone.

Examples of polycarbonate polyols include reaction products of the aforementioned polyols with alkyene carbonates such as ethylene carbonate, 1,2-propylene carbonate or 1,2-butylene carbonate, with diaryl carbonates such as diphenyl carbonate, 4-methyldiphenyl carbonate, 4-ethyldiphenyl carbonate, 4-propyldiphenyl carbonate, 4,4′-dimethyldiphenyl carbonate, 2-tolyl-4-tolyl carbonate, 4,4′-diethyldiphenyl carbonate, 4,4′-dipropyldiphenyl carbonate, phenyltolyl carbonate, bis-chlorophenyl carbonate, phenylchlorophenyl carbonate, phenylnaphthyl carbonate or dinaphthyl carbonate, or with dialkyl carbonates such as dimethyl carbonate, diethyl carbonate, di-n-propyl carbonate, diisopropyl carbonate, di-n-butyl carbonate, diisobutyl carbonate, di-t-butyl carbonate, di-n-amyl carbonate or diisoamyl carbonate.

Although one type of polyol may be used or two or more types of polyols may be used in combination, urethane (meth)acrylate, which combines the use of two or more types of polyether polyols, polyester polyols and polycarbonate polyols, is preferable, and two types of polyols are more preferably used in combination. The combined use of these polyols preferably facilitates adjustment of deformation resistance or surface hardness of the resulting cured film in a high-temperature and high-humidity environment. Preferable examples of the combined use of two types include a polyester polyol and a polycarbonate polyol in the case of increasing surface hardness, and the combined use of a polyether polyol in the case of improving deformation resistance at a high-temperature and high-humidity. The combined use of a polyether polyol and a polycarbonate polyol is preferable in the case of obtaining intermediate properties thereof.

The content of each polyol in the case of combining the use of polyols is such that the content of polyether polyol is preferably 20 to 90% by weight and more preferably 30 to 80% by weight based on the total weight of the polyols used. The content of polyester polyol is preferably 10 to 70% by weight and more preferably 20 to 60% by weight. As a result of making the contents of polyether polyol and polyester polyol to be within these ranges, surface hardness as well as humidity and heat resistance of the cured product can be easily obtained.

Preferable examples of the urethane (meth)acrylate used in the present invention include urethane acrylates having a polyether backbone such as FAU-742TP and FAU-306 manufactured by DIC Corp., urethane acrylates having a tolylene diisocyanate backbone such as FAU-1000 manufactured by DIC Corp., and urethane acrylates having a polyester backbone such as Photomer 6892 manufactured by Cognis Japan, Ltd. or Ebecryl 8405 manufactured Daicel-Cytec Co., Ltd.

The content of the urethane (meth)acrylate in the ultraviolet-curable composition of the present invention is preferably 20 to 70% by weight and more preferably 30 to 60% by weight in the ultraviolet-curable compounds contained in the ultraviolet-curable composition. As a result of making the urethane (meth)acrylate content to be within these ranges, suitable flexibility can be imparted to the cured film.

The weight average molecular weight (Mw) of the urethane (meth)acrylate used in the present invention as measured by gel permeation chromatography (GPC) is preferably 300 to 4000 and more preferably 400 to 3000. As a result, an optical disc using the ultraviolet-curable composition of the present invention has even better durability.

Furthermore, weight average molecular weight as determined by GPC is determined by using the HLC-8020 system manufactured by Tosoh Corp., using the GMHx1-GMHx1-G200Hx1-G1000Hx1w for the column, using THF for the solvent, measuring at a flow rate of 1.0 ml/min, column temperature of 40° C. and detector temperature of 30° C., and based on the standard polystyrene conversion.

In the present invention, although a composition that is substantially free of epoxy (meth)acrylate for the (meth)acrylate oligomer is preferable since this facilitates adjustment of the chlorine content in the composition, epoxy (meth)acrylate can also be used preferably provided it does not cause an increase in the chlorine content of the composition. There are no particular limitations on the epoxy (meth)acrylate provided it is obtained by a reaction between a compound having one or more epoxy groups in a molecule thereof and acrylic acid, and may be modified by polyester, polyether or rubber and the like.

[(Meth)acrylate Monomer]

In the present invention, the use of a (meth)acrylate monomer, such as a (meth)acrylate having a (meth)acryloyl group in a molecule thereof (to be abbreviated as monofunctional (meth)acrylate), a (meth)acrylate having two (meth)acryloyl groups in a molecule thereof (to be abbreviated as difunctional (meth)acrylate), or a (meth)acrylate having three or more (meth)acryloyl groups in a molecule thereof (to be abbreviated as polyfunctional (meth)acrylate), in combination with the aforementioned (meth)acrylate oligomer enables the obtaining of a composition having a desired viscosity and elastic modulus after curing.

Various types of (meth)acrylates can be used for these (meth)acrylate monomers, examples of which include monofunctional (meth)acrylates, including aliphatic (meth)acrylates such as ethyl(meth)acrylate, butyl(meth)acrylate, 2-ethylhexyl (meth)acrylate, nonyl(meth)acrylate, tridecyl(meth)acrylate, hexadecyl(meth)acrylate, octadecyl(meth)acrylate, isoamyl(meth)acrylate, isodecyl(meth)acrylate, isostearyl (meth)acrylate, ethoxyethoxyethyl(meth)acrylate, 2-hydroxyethyl(meth)acrylate, 3-chloro-2-hydroxypropyl(meth)acrylate, methoxyethyl(meth)acrylate, butoxyethyl (meth)acrylate or benzyl(meth)acrylate; aromatic(meth)acrylates such as nonylphenoxyethyl(meth)acrylate, tetrahydrofurfuryl(meth)acrylate, glycidyl (meth)acrylate, 2-hydroxy-3-phenoxypropyl (meth)acrylate, nonylphenoxyethyltetrahydrofurfuryl(meth)acrylate or phenoxyethyl(meth)acrylate; alicyclic(meth)acrylates such as dicyclopentenyl(meth)acrylate, dicyclopentanyl (meth)acrylate, dicyclopentenyloxyethyl(meth)acrylate, tetracyclododecanyl (meth)acrylate or cyclohexyl(meth)acrylate; caprolactone-modified tetrahydrofurfuryl (meth)acrylate; acryloyl morpholine; isobornyl(meth)acrylate; norbornyl(meth)acrylate and 2-(meth)acryloyloxy methyl-2-methylbicycloheptane adamantyl(meth)acrylate.

In particular, in the case of using tetrahydrofurfuryl acrylate, phenoxyethyl acrylate or ethoxyethoxyethyl acrylate, the amount of warp deformation is reduced, thereby making this preferable.

Examples of difunctional (meth)acrylates include 1,4-butanediol di(meth)acrylate, 3-methyl-1,5-pentanediol di(meth)acrylate, 1,6-hexanediol di(meth)acrylate, neopentyl glycol di(meth)acrylate, 2-methyl-1,8-octanediol di(meth)acrylate, 2-butyl-2-ethyl-1,3-propanediol di(meth)acrylate, ethylene glycol di(meth)acrylate, trimethylolpropane di(meth)acrylate, pentaerythritol di(meth)acrylate, polypropylene glycol di(meth)acrylate, di(meth)acrylates of diols obtained by adding 4 moles or more of ethylene oxide or propylene oxide to 1 mol of neopentyl glycol, ethylene oxide-modified phosphoric acid (meth)acrylates, ethylene oxide-modified alkylated phosphoric acid di(meth)acrylates, diethylene glycol di(meth)acrylate, dipropylene glycol di(meth)acrylate, tripropylene glycol di(meth)acrylate, polyether (meth)acrylate and diethylaminoethyl (meth)acrylate, as well as (meth)acrylates having an alicyclic structure including alicyclic difunctional (meth)acrylates such as norbornane dimethanol di(meth)acrylate, norbornane diethanol di(meth)acrylate, di(meth)acrylates of diols obtained by adding 2 moles of ethylene oxide or propylene oxide to norbornane dimethanol, tricyclodecane dimethanol di(meth)acrylate, tricyclodecane diethanol di(meth)acrylate, di(meth)acrylates of diols obtained by adding 2 moles of ethylene oxide or propylene oxide to tricyclodecane dimethanol, pentacyclopentadecane dimethanol di(meth)acrylate, pentacyclopentadecane diethanol di(meth)acrylate, di(meth)acrylates of diols obtained by adding 2 moles of ethylene oxide or propylene oxide to pentacyclopentadecane dimethanol, di(meth)acrylates of diols obtained by adding 2 moles of ethylene oxide or propylene oxide to pentacyclopentadecane diethanol, dimethylol dicyclopentane di(meth)acrylate or hydroxypivalic acid neopentyl glycol di(meth)acrylate.

Furthermore, tricyclodecane dimethanol di(meth)acrylate, tripropylene glycol di(meth)acrylate, dipropylene glycol di(meth)acrylate and hydroxypivalic acid neopentyl glycol di(meth)acrylate are preferable, while tripropylene glycol di(meth)acrylate is particularly preferable.

In addition, in the case of desiring to adjust to a high elastic modulus after curing, trifunctional or more highly functional (meth)acrylates can be used. For example, polyfunctional (meth)acrylates such as bis(2-acryloyloxyethyl)hydroxyethyl isocyanurate, bis(2-acryloyloxypropyl)hydroxypropyl isocyanurate, bis(2-acryloyloxybutyl)hydroxybutyl isocyanurate, bis(2-methacryloyloxyethyl)hydroxyethyl isocyanurate, bis(2-methacryloyloxypropyl)hydroxypropyl isocyanurate, bis(2-methacryloyloxybuty)hydroxybutyl isocyanurate, tris(2-acryloyloxyethyl) isocyanurate, tris(2-acryloyloxypropyl)isocyanurate, tris-(2-acryloyloxybutyl) isocyanurate, tris(2-methacryloyloxyethyl)isocyanurate, tris(2-meth acryloyloxypropyl) isocyanurate, tris(2-methacryloyloxybutyl)isocyanurate, trimethylolpropane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, dipentaerythritol hexa(meth)acrylate, di- or tri(meth)acrylates of triols obtained by adding 3 moles or more of ethylene oxide or propylene oxide to 1 mole of trimethylolpropane or poly(meth)acrylates of dipentaerythritol can be used.

In addition, ultraviolet-curable compounds such as N-vinylpyrrolidone, N-vinylcaprolactam or vinyl ether monomers can be used as necessary.

The content of monofunctional (meth)acrylate contained in the total amount of ultraviolet-curable compounds contained in the ultraviolet-curable composition in the present invention is preferably 3 to 30% by weight and more preferably 5 to 25% by weight. The content of difunctional (meth)acrylate is preferably 3 to 30% by weight and more preferably 5 to 20% by weight. In addition, the content of trifunctional or more highly functional (meth)acrylate is preferably 25% by weight or less and more preferably 20% by weight or less.

[Antioxidant]

In the present invention, an antioxidant having an isocyanuric acid backbone is used for the antioxidant. Since the isocyanuric acid backbone in the antioxidant has high affinity for silicon or silicon compounds, adhesion is favorable at the interface between a cured coating film of an ultraviolet-curable composition containing this antioxidant and silicon or silicon compounds. As a result, the occurrence of deterioration-causing penetration of silicon or silicon compound onto the surface of the light reflecting layer in a high-temperature and high-humidity environment, along with the occurrence of deterioration, can be preferably inhibited, thereby making it possible to decrease the formation of minute white spots.

Antioxidants represented by formula (1), for example, can be preferably used for the antioxidant having an isocyanuric acid backbone.

[Chemical 1]

X—[—Y-Z]₃ (I)

[In formula (1), X represents a trivalent group represented by formula (2):

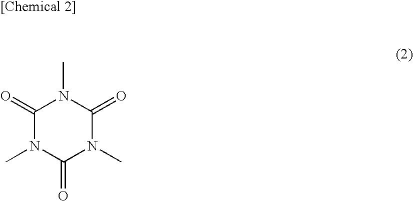

Y represents a divalent group represented by formula (3):

[Chemical 3]

—(CH₂)ₙ— (3)

(wherein, n is 1 to 3), and Z represents a monovalent group represented by formula (4):

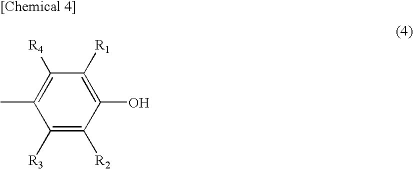

(wherein, R₁ and R₂ each independently represent a methyl group or tert-butyl group, at least one of R₁ and R₂ represents a tert-butyl group, and R₃ and R₄ each independently represent a hydrogen atom or a methyl group), or by formula (5):

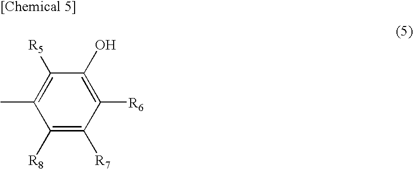

(wherein, R₅ and R₆ each independently represent a methyl group or tert-butyl group, at least one of R₅ and R₆ represents a tert-butyl group, and R₇ and R₈ each independently represent a hydrogen atom or a methyl group)].

Since a compound represented by formula (1) has a structure represented by formula (4) or formula (5) in which an easily oxidized hydroxyl group is adjacent to a tert-butyl group that inhibits oxidation of the hydroxyl group, and that structure is arranged centering about the isocyanuric acid backbone represented by the aforementioned formula (2), it is able to preferably inhibit deterioration of silicon or silicon compounds.

In particular, since an antioxidant, in which Z in formula (1) has a structure represented by formula (4) and R₁ and R₂ in formula (4) are both tert-butyl groups, has an easily oxidized hydroxyl group on the terminal thereof and has a structure in which tert-butyl groups are adjacent to the hydroxyl group on both sides thereof, it preferably demonstrates oxidation controlling effects, and is preferable since it is able to particularly preferably inhibit deterioration of silicon or silicon compounds, with a compound in which n in formula (3) is 1 being particularly preferable. Commercially available examples of compounds represented by formula (1) include Irganox 3114 and Irganox 3790 (both manufactured by Ciba Specialty Chemicals Inc.).

[Ultraviolet-Curable Composition]

The ultraviolet-curable composition of the present invention contains the aforementioned (meth)acrylate oligomer, the (meth)acrylate monomer and the antioxidant, and is an ultraviolet-curable composition for an optical disc in which the chlorine content in the composition is less than 120 ppm. In the present invention, together with using a compound represented by the aforementioned formula (1), by making the chlorine content less than 120 ppm, preferably less than 110 ppm and more preferably less than 105 ppm, oxidation of silicon or silicon compounds that progresses at a high-temperature and high-humidity can be prevented, and deterioration of silicon or silicon compounds can be preferably inhibited.

The chlorine content in the composition is measured using the ZSX Purimus wavelength dispersive X-ray fluorescence spectrometer manufactured by Rigaku Corp., using a beryllium filter in a helium atmosphere, setting the fixed-angle measurement elements to chlorine, sulfur, phosphorous, silicon and sodium, setting the angle fixation time to 20 seconds each for both peak and background, using an irradiated surface area of 30 mmφ in diameter, and measuring using the total element qualitative analysis and fixed-angle measurement mode. Chlorine content is determined according to the thin film FP method.

A coating film can be preferably formed by making the viscosity of the ultraviolet-curable composition of the present invention is 200 to 1000 mPa·s and preferably 300 to 800 mPa·s.

The elastic modulus of a cured film after irradiating the ultraviolet-curable composition of the present invention with ultraviolet light is preferably adjusted to be 100 to 3000 MPa (at 25° C.). In particular, a composition in which the elastic modulus is 200 to 2500 MPa is more preferable. If the elastic modulus of the composition is within these ranges, strain during curing is easily alleviated, thereby allowing the obtaining of an optical disc having a small change in warping even when exposed to a high-temperature and high-humidity environment for a long period of time. In addition, the elastic modulus of the cured film is preferably adjusted to 200 to 2500 MPa (at 25° C.), and if the modulus of elasticity of the composition is within this range, there is little deterioration of the error rate of recording signals when forming the optical disc, thereby facilitating the formation of an optical disc having superior reliability.

In addition to the aforementioned (meth)acrylate oligomer, (meth)acrylate monomer and antioxidant, known photopolymerization initiators, thermal polymerization initiators and the like can be used in the ultraviolet-curable composition for an optical disc of the present invention.

Examples of photopolymerization initiators are able to be used in the present invention including molecular cleavage types such as benzoin isobutyl ether, 2,4-diethylthioxanthone, 2-isopropylthioxanthone, benzyl 1-hydroxycyclohexyl phenyl ketone, benzoin ethyl ether, benzyl dimethyl ketal, 2-hydroxy-2-methyl-1-phenylpropan-1-one, 1-(4-isopropylphenyl)-2-hydroxy-2-methylpropan-1-one, 2,4,6-trimethylbenzoyldiphenyl phosphine oxide or 2-methyl-1-(4-methylthiophenyl)-2-morpholinopropan-1-one; and hydrogen abstraction types such as benzophenone, 4-phenylbenzophenone, isophthalophenone or 4-benzoyl-4′-methyl-diphenylsulfide.

A surfactant, leveling agent, thermal polymerization inhibitor, hindered phenols, phosphites and other antioxidants or hindered amines and other light stabilizers can also be added as necessary to the ultraviolet-curable composition used in the present invention. In addition, trimethylamine, methyl dimethanolamine, triethanolamine, p-dimethylaminoacetophenone, ethyl p-dimethylaminobenzoate, isoarnyl p-dimethylaminobenzoate, N,N-dimethylbenzylamine and 4,4′-bis(diethylamino)benzophenone, for example, can be used as a sensitizer. Moreover, amines not causing an addition reaction with the aforementioned photopolymerizable compounds can also be used in combination.

[Optical Disc]

The optical disc of the present invention has a light reflecting layer composed of silicon or silicon compound, and employs a constitution in which a cured coating film of the aforementioned ultraviolet-curable composition for an optical disc is laminated directly on the light reflecting layer. As a result of employing this constitution, the optical disc using the ultraviolet-curable composition of the present invention is resistant to deterioration of the light reflecting layer, which becomes an impairment when reading and writing signals even at a high-temperature and high-humidity, and is able to preferably read and write audio and video signals as well as other special signals and the like.

An optical disc having this structure is an optical disc having, for example, a structure in which a first reflective film for reflecting laser light for reading information is provided on a first substrate, and a resin layer composed of a cured film of the aforementioned ultraviolet-curable composition is further provided on the first reflective film. The optical disc of the present invention is an optical disc employing such a structure or an optical disc partially employing that structure. Examples of such optical discs include CD-ROM or CD-R having a light reflecting layer composed of silicon or a silicon compound, and provided with a protective layer in the form of a resin layer composed of a cured film of the ultraviolet-curable composition on the light reflecting layer. In addition, another example is a DVD-5 in which a substrate having a light reflecting layer composed of silicon or a silicon compound is laminated with another substrate composed of an ultraviolet-curable composition by using the light reflecting layer as an adhesive surface.

In addition, the optical disc using the ultraviolet-curable composition for an optical disc of the present invention may also be an optical disc having a structure in which a second substrate, which is provided with a second reflective film for reflecting laser light for reading information, is further provided on the resin layer composed of a cured film of the ultraviolet-curable composition provided on the first reflective film so that the resin layer and the second reflective film make contact. Examples of an optical disc having such a structure include DVD-9, DVD-18, DVD-10 and other laminated-type optical discs in which at least one of the two optical disc substrates provided with a reflective layer for reflecting laser light for reading information has a light reflecting layer composed of silicon or a silicon compound on the surface thereof, and the two optical disc substrates are laminated by using the light reflecting layers of the two substrates as adhesive surfaces.

A disc-shaped, circular resin substrate can be used as a substrate, and polycarbonate can be used as a preferable example of a resin. In the case the optical disc is for read-only, pits responsible for recording information on the substrate are formed in the surface that is laminated with the light reflecting layer.

The resin layer composed of the aforementioned ultraviolet-curable composition present in the optical disc preferably efficiently transmits light, and total light transmittance at a thickness of 50 μm is preferably 85% or more and particularly preferably 90% or more.

The thickness of the resin layer may be a thickness that is suitable based on the constitution of the optical disc, and in the case the optical disc is a DVD-9, for example, the thickness of the resin layer is preferably 40 to 70 μm.

The type of optical disc is preferably a read-only DVD in the form of a “DVD-5”, “DVD-10”, “DVD-9” or “DVD-18”, and particularly preferably a read-only DVD in the form of a “DVD-9”.

In the case the ultraviolet-curable composition coated onto the light reflecting layer is cured by irradiating with ultraviolet light, irradiation can be carried out by a continuous light irradiation system using, for example, a metal halide lamp or high-pressure mercury lamp, or can be carried out by a flashlight irradiation system as described in U.S. Pat. No. 5,904,795. A flashlight irradiation system is more preferable with respect to enabling efficient curing.

In the case of irradiating with ultraviolet light, the accumulated light intensity is preferably controlled to 0.05 to 1 J/cm². The accumulated light intensity is more preferably 0.05 to 0.8 J/cm² and particularly preferably 0.05 to 0.6 J/cm². The ultraviolet-curable composition used in the optical disc of the present invention is sufficiently cured even if the accumulated light intensity is low, does not cause tacking on the edges or surface of the optical disc, and does not cause warping or strain of the optical disc.

During the course of irradiation with ultraviolet light, irradiation can be carried out with a continuous light irradiation system using, for example, a metal halide lamp or high-pressure mercury lamp, or with a flashlight irradiation system. A flashlight irradiation system is more preferable with respect to enabling efficient curing.

The following describes examples in the case of producing a “DVD-5”, “DVD-10”, “DVD-9” and “DVD-18”. However, examples of the optical disc of the present invention are not limited thereto. In addition, the ultraviolet-curable compositions used in the following production examples refer to ultraviolet-curable compositions containing a compound represented by the aforementioned formula (1) used in the present invention.

(DVD-9 Production)

An optical disc substrate (A) (second substrate), in which a 40 to 60 nm metal thin film (second reflective film) was laminated on concave-convexes known as pits responsible for recording information, and an optical disc substrate (B) (first substrate), in which a 10 to 30 nm translucent reflective film (translucent reflective film: first reflective film) composed of an alloy having silicon or a silicon compound as the main component thereof was laminated on concave-convexes known as pits responsible for recording information, are prepared.

Furthermore, an alloy having aluminum as the main component thereof or silver or an alloy having silver as the main component thereof, for example, can be used for the second reflective film. In addition, a substrate commonly known as an optical disc substrate can be used for the optical disc substrate. Examples of substrates include amorphous polyolefins, polymethyl methacrylate and polycarbonate, with a polycarbonate substrate being used particularly preferably.

Next, the ultraviolet-curable composition is coated onto the metal thin film (second reflective film) of the substrate (A) (second substrate), and the substrate B (first substrate), on which the translucent reflective film (first reflective film) is laminated, is laminated with the substrate (A) (second substrate) with the ultraviolet-curable composition coated on the surface of the metal thin film (second reflective film) interposed there between so that the film surface of the translucent reflective film (first reflective film) serves as the adhesive surface, after which the one side or both sides of the two laminated substrates is irradiated with ultraviolet light to adhere the two and obtain a “DVD-9”.

(DVD-18 Production)

Moreover, after having produced the DVD-9, by separating only the substrate (A) (second substrate) while leaving the metal thin film (second reflective film) formed on the substrate (A) (second substrate) on the side of the substrate (B) (first substrate), a disc intermediate is produced in which the substrate (B) (first substrate), the translucent reflective film (first reflective film), a cured film of the ultraviolet-curable composition and the metal thin film (second reflective film) are sequentially laminated in that order. Two of these disc intermediates are prepared. Next, these two disc intermediates are adhered by using the metal thin films (first reflective films) thereof as adhesive surfaces so that those surfaces are in mutual opposition to obtain a “DVD-18”.

(DVD-10 Production)

Two substrates for an optical disc consisting of a substrate (C1) (first substrate) and a substrate (C2) (second substrate) are prepared in which a 40 to 60 nm reflective film composed of an alloy having silicon or a silicon compound as the main component thereof is laminated on concave-convexes known as pits responsible for recording information. The ultraviolet-curable composition is coated onto a reflective film (first reflective film) of one of the substrates (C1) (first substrate), the other substrate (C2) (second substrate) is laminated with the first substrate (C1) (first substrate) with the composition coated on the reflective film (first reflective film) of the substrate (C1) (first substrate) interposed there between so that the film surface of the reflective film (second reflective film) serves as the adhesive surface, after which one or both sides of the two laminated substrates is irradiated with ultraviolet light to adhere the two and obtain a “DVD-10”.

(DVD-5 Production)

A substrate for an optical disc (D) (first substrate) is prepared in which a 40 to 60 nm metal thin film (first reflective film) composed of an alloy having silicon or a silicon compound as the main component thereof is laminated onto concave-convexes known as pits responsible for recording information. Separate from this, a substrate for an optical disc (E) is prepared that does not have pits. The ultraviolet-curable composition is coated onto the first reflective film of the substrate (D) (first substrate), and the substrate (D) (first substrate) is laminated with the substrate (E) with the composition interposed there between, after which one or both sides of the two laminated substrates is irradiated with ultraviolet light to adhere the two and obtain a “DVD-5”.

### EXAMPLES

### Examples 1 to 4 and Comparative Examples 1 to 5

The raw materials of each composition were melted by heating for 3 hours at 60° C. and ultraviolet-curable compositions of each of the examples and comparative examples were prepared according to the blending compositions shown in the following Tables 1 and 2.

DVD-9 laminated discs were produced using the resulting ultraviolet-curable compositions, and durability was evaluated according to the test method described below. The results are shown in the lower portions of Tables 1 and 2.

(Measurement of Chlorine Content)

Chlorine content in the compositions was measured using the ZSX Purimus wavelength dispersive X-ray fluorescence spectrometer manufactured by Rigaku Corp., using a beryllium filter in a helium atmosphere, setting the fixed-angle measurement elements to chlorine, sulfur, phosphorous, silicon and sodium, setting the angle fixation time to 20 seconds each for both peak and background, using an irradiated surface area of 30 mmφ in diameter, and measuring using the total element qualitative analysis and fixed-angle measurement mode. Chlorine content was determined according to the thin film FP method.

(DVD-9 Laminated Disc Durability Test)

The ultraviolet-curable compositions of each of the examples and comparative examples were coated with a dispenser onto a polycarbonate substrate in which information recording pits were formed and in which an aluminum thin film having a thickness of 50 nm was laminated so as to cover the pits, and a polycarbonate disc substrate, in which silicon was laminated as a translucent reflective film, was laminated so that the translucent reflective film contacted the ultraviolet-curable composition. Next, the laminated disc was rotated with a spin coater so that the film thickness of the cured film was 50 to 60 μm. Next, the laminated disc was irradiated with ultraviolet light in air from the side of the translucent reflective film using an ultraviolet curing device manufactured by Eye Graphics Co., Ltd. with a metal halide lamp (equipped with a cold mirror, lamp output: 120 W/cm) and at an accumulated light intensity of 0.1 J/cm² to produce DVD-9 using each of the compositions.

The number of PI errors was measured for the produced discs at an inner peripheral region (position: 24.50 to 25.00 mm) and intermediate peripheral region (position: 40.03 to 40.51 mm) using the SA-300 manufactured by AudioDev AB. The average value of the inner and intermediate peripheral regions was used for the number of PI errors.

Subsequently, an environmental test was carried out for 240 hours at 80° C. and 85% RH using the Etac constant-temperature and constant-humidity chamber manufactured by Espec Corp. The number of PI errors was measured for each disc following testing.

The PI error ratio (the number of PI errors after environmental testing/the number of PI errors before environmental testing) was determined from the number of PI errors before and after environmental testing.

Discs in which the PI error ratio was less than 2 were evaluated as ∘, while those in which the PI error ratio was 2 or more were evaluated as ×.

(Post-Durability Test Appearance)

The appearance of the optical discs after the durability test was confirmed using the VHX-200 Digital Microscope manufactured by Keyence Corp (magnification: 25×).

Those discs that were free of defects were evaluated as ∘, those in which white lump-like defects were able to be confirmed were evaluated as ×, while those in which white lump-like defects were frequently observed were evaluated as ××.

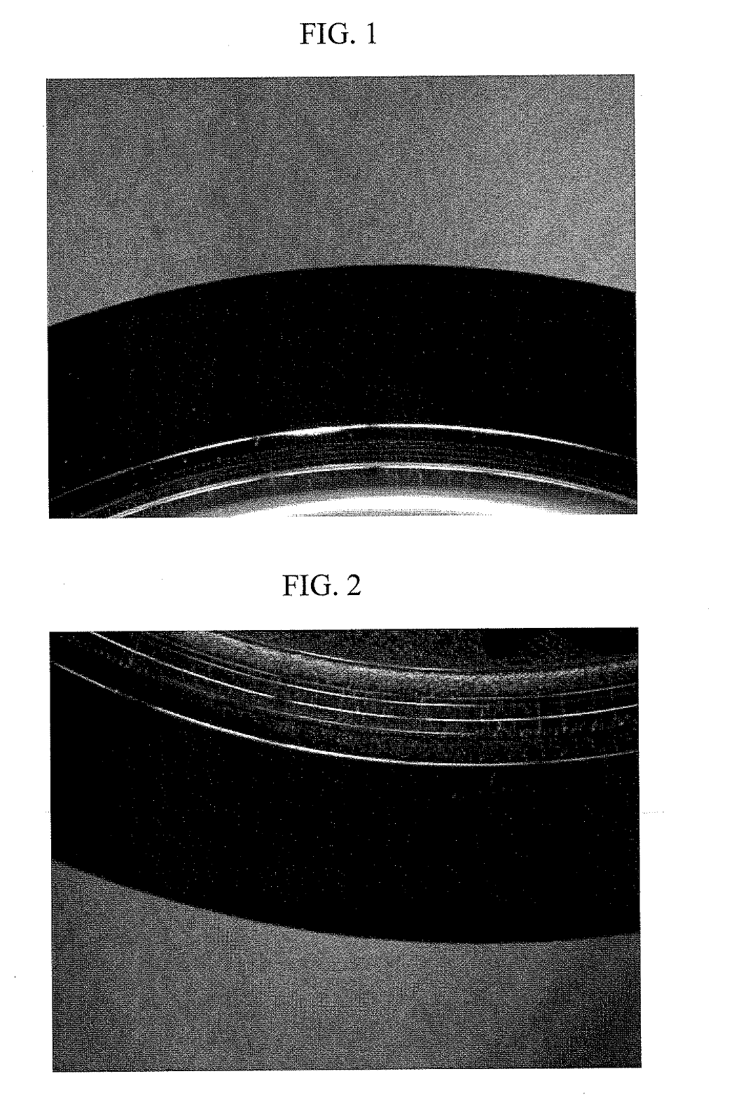

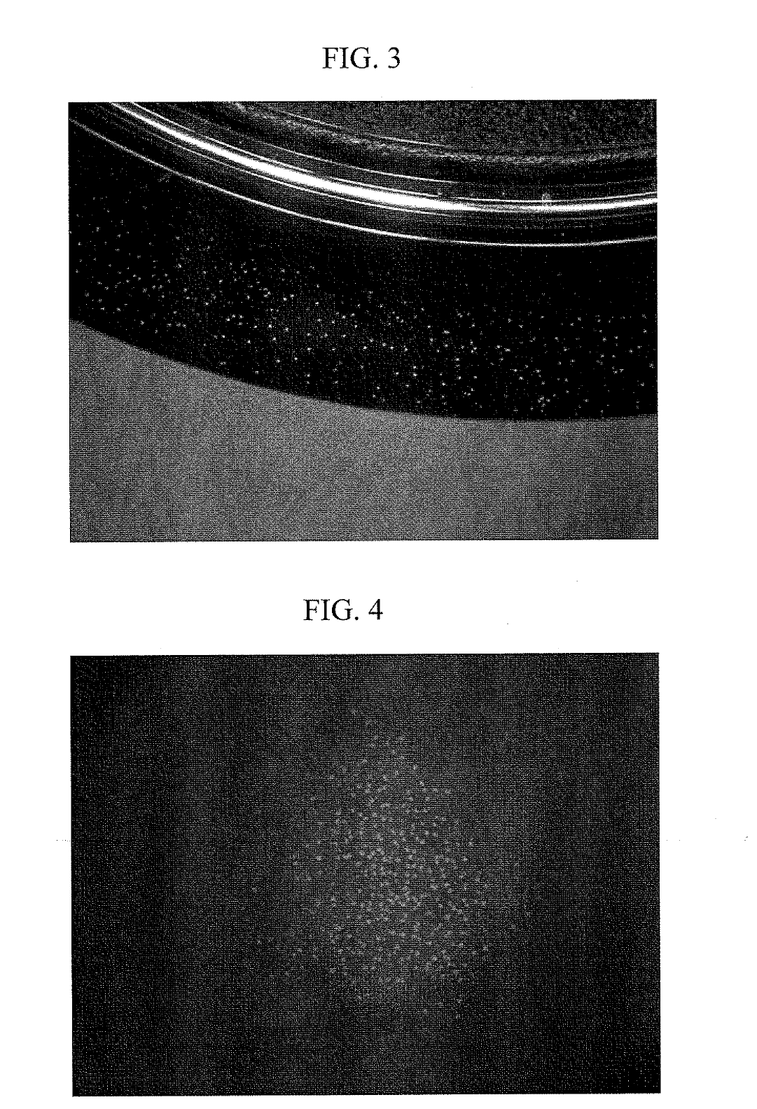

In addition, the observation results for Examples 1 and 3 and Comparative Examples 1 and 3 are shown in FIGS. 1 to 4.

(Measurement of Elastic Modulus)

After coating the ultraviolet cured compositions onto a glass plate to a cured film thickness of 100±10 μm, the coating films were cured using a metal halide lamp (equipped with a cold mirror, lamp output: 120 W/cm) and at an accumulated light intensity of 0.5 J/cm² in a nitrogen atmosphere. The elastic modulus of the cured films was measured as the dynamic elastic modulus E′ at 25° C. by measuring with an automated dynamic viscoelasticity measuring device manufactured by TA Instruments Inc.

TABLE 1

| | | | Example 1 | | Example 2 | | Example 3 | | Example 4 | |
|---|---|---|---|---|---|---|---|---|---|---|
| Composition | Urethane | UA | 49 | | 18 | | 18 | | 18 | |
| | oligomer | FAU-1000 | | | 31 | | 31 | | 31 | |
| | | Photomer | | | | | | | | |
| | | 6019 | | | | | | | | |
| | Epoxy oligomer | Photomer | | | | | | | | |
| | | 3016 | | | | | | | | |
| | Monomer | TMP(3EO)TA | 17 | | 17 | | 17 | | 17 | |
| | | TPGDA | 10 | | 10 | | 10 | | 10 | |
| | | THFA | 18 | | 18 | | 18 | | 10 | |
| | | PHE | | | | | | | 8 | |
| | | Phosphoric | 0.05 | | 0.05 | | 0.05 | | 0.05 | |
| | | acid | | | | | | | | |
| | | methacrylate | | | | | | | | |
| | Photo- | HCPK | 5 | | 5 | | 5 | | 5 | |
| | polymerization | TPO | 1 | | 1 | | 1 | | 1 | |
| | initiator | | | | | | | | | |
| | Antioxidant | IRGANOX 3114 | 0.2 | | 0.1 | | 0.2 | | 0.1 | |
| | | Gallic acid | | | | | | | | |
| Evaluation | Post-durability | 80° C., 85% RH, | ◯ | | ◯ | | ◯ | | ◯ | |
| | test appearance | 240 hours | | | | | | | | |
| | PI error ratio | 80° C., 85% RH, | ◯ | | ◯ | | ◯ | | ◯ | |
| | | 240 hours | 1.18 | | 1.33 | | 1.18 | | 1.23 | |
| | Elastic modulus | 25° C. | 240 | MPa | 2100 | MPa | 2100 | MPa | 2100 | MPa |
| | E′ | | | | | | | | | |

| | | | | | | | | |
|---|---|---|---|---|---|---|---|---|
| Chlorine content | 100 | ppm | 102 | ppm | 102 | ppm | 100 | ppm |
| in the composition | | | | | | | | |

TABLE 2

| | | | Comp. | | Comp. | | Comp. | | Comp. | | Comp. | | Comp. | |
|---|---|---|---|---|---|---|---|---|---|---|---|---|---|---|
| | | | Ex. 1 | | Ex. 2 | | Ex. 3 | | Ex. 4 | | Ex. 5 | | Ex. 6 | |
| Composition | Urethane | UA | 18 | | | | 49 | | 28 | | 18 | | 18 | |
| | oligomer | FAU-1000 | 31 | | | | | | | | 31 | | 31 | |
| | | Photomer | | | 46 | | | | | | | | | |
| | | 6019 | | | | | | | | | | | | |
| | Epoxy oligomer | Photomer | | | 6 | | 3 | | 14 | | 3 | | | |
| | | 3016 | | | | | | | | | | | | |
| | Monomer | TMP(3EO)TA | 17 | | 17 | | 14 | | 19 | | 14 | | 17 | |
| | | TPGDA | 10 | | 10 | | 10 | | 10 | | 10 | | 10 | |
| | | THFA | 18 | | 15 | | 18 | | 18 | | 18 | | 18 | |
| | | PHE | | | | | | | | | | | | |
| | | Phosphoric | 0.05 | | 0.05 | | 0.05 | | 0.05 | | 0.05 | | 0.05 | |
| | | acid | | | | | | | | | | | | |
| | | methacrylate | | | | | | | | | | | | |
| | Photo- | HCPK | 5 | | 5 | | 5 | | 5 | | 5 | | 5 | |
| | polymerization | TPO | 1 | | 1 | | 1 | | 1 | | 1 | | 1 | |
| | initiator | | | | | | | | | | | | | |
| | Antioxidant | IRGANOX 3114 | | | | | 0.2 | | 0.1 | | 0.2 | | | |
| | | Gallic acid | | | | | | | | | | | 0.2 | |
| Evaluation | Post-durability | 80° C., 85% RH, | X | | XX | | X | | X | | X | | X | |
| | test appearance | 240 hours | | | | | | | | | | | | |
| | PI error ratio | 80° C., 85% RH, | X | | X | | X | | X | | X | | ◯ | |
| | | 240 hours | 6.25 | | 4.75 | | 4.21 | | 3.47 | | 3.33 | | 1.52 | |
| | Elastic modulus | 25° C. | 2100 | MPa | 2400 | MPa | 280 | MPa | 940 | MPa | 2500 | MPa | 2100 | MPa |
| | E′ | | | | | | | | | | | | | |

| | | | | | | | | | | | | |
|---|---|---|---|---|---|---|---|---|---|---|---|---|
| Chlorine content | 102 | ppm | 179 | ppm | 140 | ppm | 324 | ppm | 143 | ppm | 102 | ppm |
| in the composition | | | | | | | | | | | | |

The compounds shown in Tables 1 and 2 are as indicated below.

UA: Urethane diacrylate (Mw: 2100) obtained by reacting 1 mole of polypropylene glycol (Mw: 1000) and 2 moles of tolylene diisocyanate followed by reacting with hydroxyethyl acrylate

FAU-1000: Urethane acrylate manufactured by DIC Corp. (urethane diacrylate obtained by reacting 2 moles of 2-hydroxypropyl acrylate with 1 mole of 2,4-tolylene diisocyanate, Mw: 434)

Photomer 6019: Urethane triacrylate from which 20% tripropylene glycol diacrylate has been removed manufactured by Cognis Japan Ltd. (G-PPG/IPDI/HEA, Mw=1500, G-PPG: glycerin-modified propylene glycol diacrylate, IPDI: isophorone diisocyanate, HEA: 2-hydroxyethyl acrylate)

Photomer 3016: Bisphenol A epoxy diacrylate manufactured by Cognis Japan Ltd. (Mw: 1300)

TMP(3EO)TM: Triacrylate of triol obtained by adding 3 moles of ethylene oxide to 1 mole of trimethylolpropane

TPGDA: Tripropylene glycol diacrylate

THFA: Tetrahydrofurfuryl acrylate

PHE: Phenoxyethyl acrylate

Phosphoric acid methacrylate: Ethylene oxide-modified phosphoric acid dimethacrylate PM-2 manufactured by Nippon Kayaku Co., Ltd.

HCPK: 1-hydroxycyclohexyl phenyl ketone

TPO: Trimethylphenyldiphenyl phosphine oxide

IRGANOX 3114: 1,3,5-tris(3,5-di-tert-butyl-4-hydroxybenzyl)-1,3,5-triazine-2,4,6-(1H,3H,5H)-trione manufactured by Ciba Specialty Chemicals Inc.

As shown in Tables 1 and 2, the produced optical discs of Examples 1 to 4, wherein chlorine content attributable to the oligomer in the composition of the present invention was less than-120 ppm and a compound represented by formula (1) was comprised therein, demonstrated low PI error ratios along with favorable durability in a high-temperature and high-humidity environment. The appearance of the optical discs following durability testing was also free of defects.

On the other hand, Comparative Example 1, which did not contain a compound represented by formula (1) but had a chlorine content of less than 120 ppm, Comparative Example 2, which did not contain a compound represented by formula (1) and had a chlorine content of 120 ppm or more, and Comparative Examples 3 to 5, which contained a compound represented by formula (1) and had a chlorine content of 120 ppm or more, all demonstrated high PI error ratios, and did not exhibit durability in a high-temperature and high-humidity environment. The appearance of these optical discs following durability testing was such that white and lump-like defects were observed that extended beyond the polycarbonate substrate, resulting in a poor appearance.

1. An ultraviolet-curable composition for an optical disc comprising a (meth)acrylate oligomer, a (meth)acrylate monomer and an antioxidant, wherein the antioxidant is an antioxidant having an isocyanuric acid backbone, and the chlorine content in the composition is less than 120 ppm.

2. The ultraviolet-curable composition for an optical disc according to claim 1, wherein the antioxidant is represented by formula (1):
[Chemical 1]
X—[—Y-Z]₃ (1)
[in formula (1), X represents a trivalent group represented by formula (2): 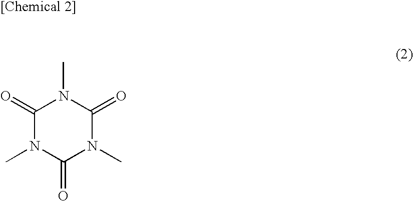
Y represents a divalent group represented by formula (3):
[Chemical 3]
—(CH₂)ₙ— (3)
(in formula (3), n is 1 to 3), and Z represents a monovalent group represented by formula (4): 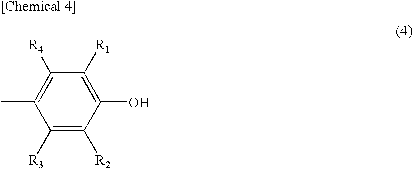
(in formula (4), R₁ and R₂ each independently represent a methyl group or tert-butyl group, at least one of R₁ and R₂ represents a tert-butyl group, and R₃ and R₄ each independently represent a hydrogen atom or a methyl group), or by formula (5): 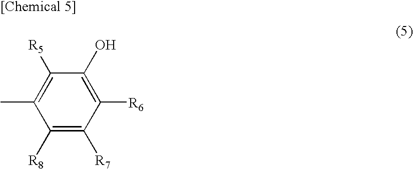
(in formula (5), R₅ and R₆ each independently represent a methyl group or tert-butyl group, at least one of R₅ and R₆ represents a tert-butyl group, and R₇ and R₈ each independently represent a hydrogen atom or a methyl group)].

3. An optical disc having a light reflecting layer composed of silicon or a silicon compound and having a cured coating film of an ultraviolet-curable composition on the light reflecting layer, wherein the ultraviolet-curable composition is the ultraviolet-curable composition for an optical disc according to claim 1.

4. An optical disc having a light reflecting layer composed of silicon or a silicon compound and having a cured coating film of an ultraviolet-curable composition on the light reflecting layer, wherein the ultraviolet-curable composition is the ultraviolet-curable composition for an optical disc according to claim 2.
